(19) United States
(12) Patent Application Publication
(10) Pub. No.: US 2015/0161569 A1
(43) Pub. Date: Jun. 11, 2015

(54) SYSTEM FOR SIMPLIFICATION OF A CALENDAR INTERFACE

(71) Applicant: Kavaanu, Inc., Mountain View, CA (US)

(72) Inventors: Yoav Shoham, Los Altos Hills, CA (US); Jacob Bank, Stanford, CA (US); Kumiko Toft, Palo alto, CA (US); Annika Matta, Mountain View, CA (US); Zachary Weiner, Berkeley, CA (US); Brian Frank, San Francisco, CA (US)

(73) Assignee: Kavaanu, Inc., Mountain View, CA (US)

(21) Appl. No.: 14/101,081

(22) Filed: Dec. 9, 2013

(51) Int. Cl. G06Q 10/10

(52) U.S. Cl. CPC G06Q 10/1093

(57) ABSTRACT

A system, computer-readable storage medium storing at least one program, and computer-implemented method for presenting a calendar interface is presented. The method may include accessing a set of calendar objects of a user corresponding to calendar events of a user calendar. The calendar events may comprise at least one foreground calendar event for which non-optional user attendance is indicated, and a background calendar event for which optional user attendance is indicated. The method may further include generating a calendar interface with a compressed display of the background calendar event, and an expanded display of the foreground calendar objects.

### TECHNICAL FIELD

Example embodiments of the present application generally relate to data processing and, more particularly, to a system and method for providing personal information management services to users.

### BACKGROUND

Classically, task management involved creating and maintaining one or more paper to-do lists. With the proliferation of mobile computing, task management is now typically handled electronically by way of task management software tools. Traditional task management software tools allow users to manage multiple tasks on multiple task lists, share tasks with other users, set alerts and reminders for certain tasks, and prioritize tasks based on the wishes of the user.

The task lists of traditional task management tools are often outdated, unstructured, and incomplete or unmanageably long. The information for describing individual tasks is often scant, containing little more than a subject and a due date. As a result, the tasks on these lists are often mismanaged and quickly become irrelevant or moot due to the passing of time or a change in other circumstances. Further, although these task management tools allow users to schedule tasks in an electronic calendar, these electronic calendars often become cluttered with events the user does not actually plan to attend. The view of events the user plans to attend may become obscured by these events, and as a result, the calendar may become mismanaged or unusable.

### BRIEF DESCRIPTION OF THE DRAWINGS

Some embodiments are illustrated by way of example and not limitation in the figures of the accompanying drawings.

FIG. 1 is a network diagram depicting an example network system 100, according to one embodiment, having a client-server architecture configured for exchanging data over a network.

FIG. 2 is a block diagram illustrating an example embodiment of the multiple modules forming the task management application 128, which are provided as part of the task management platform 102.

FIG. 3 is a high-level relationship diagram, in accordance with an example embodiment, illustrating various attributes that are included in a calendar object.

FIG. 4 is an interface diagram illustrating a portion of a calendar object creation interface, according to some embodiments.

FIG. 5 is an interface diagram illustrating an example calendar source management interface, consistent with some embodiments.

FIG. 6 is a flowchart illustrating an example method for presenting a background calendar event, according to an example embodiment.

FIG. 7A is an interface diagram illustrating an example calendar interface, according to some embodiments.

FIG. 7B is an interface diagram illustrating the calendar interface with an expanded display of a background calendar event, consistent with some embodiments.

FIG. 7C is an interface diagram illustrating the calendar interface with an all-day calendar event, consistent with some embodiments.

FIG. 7D is an interface diagram illustrating the calendar interface with multiple all-day calendar events, consistent with some embodiments.

FIG. 7E is an interface diagram illustrating the calendar interface with a compressed display of an all-day background calendar event, consistent with some embodiments.

FIG. 8 is a block diagram illustrating an example method for updating the calendar interface, consistent with some embodiments.

FIG. 9 is an interface diagram illustrating a detailed view 900 of an example calendar object, according to some embodiments.

FIG. 10 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details. In accordance with the present disclosure, components, process steps, and data structures may be implemented using various types of operating systems, programming languages, computing platforms, computer programs, and/or general purpose machines.

Aspects of the present disclosure describe systems and methods for presenting a calendar interface. Consistent with some embodiments, the calendar interface may include a display of two classes of calendar events: foreground calendar events and background calendar events. The background calendar events correspond to activities (e.g. meetings, events, etc.) that a user designated as optional (e.g., the user has not committed to the event), but would nonetheless prefer to be aware of Foreground calendar events, on the other hand, are events for which the user has committed to (e.g., a meeting the user is planning on attending). Background calendar events are presented differently than foreground calendar events in the calendar so as to prevent the calendar from becoming cluttered with information.

Consistent with some embodiments, the method may include accessing a set of calendar objects of a user. The set of calendar objects correspond to calendar events of a user calendar. The calendar events may include foreground calendar events and at least one background calendar event. The method may further include generating a calendar interface with a display of the foreground calendar events, and an unobtrusive display of at least one background calendar event.

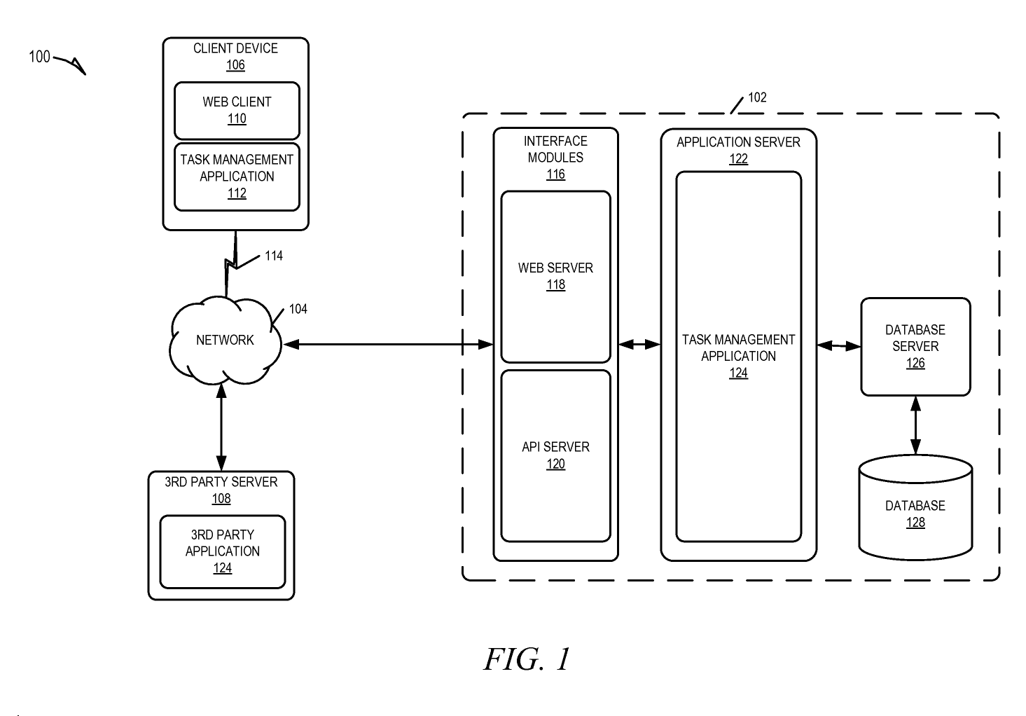

FIG. 1 is a network diagram depicting an example network system 100, according to one embodiment, having a client-server architecture configured for exchanging data over a network. Although the system 100 illustrated in FIG. 1 employs a client-server architecture, the present inventive subject matter is, of course, not limited to such an architecture, and could equally well find application in an event-driven, distributed, or peer-to-peer architecture system, for example.

The network system 100 may include a task management platform 102 to provide clients with intelligent task management services. The task management platform 102 may provide server-side functionality, via a network 104 (e.g., the Internet), to one or more client devices 106, and to one or more third party servers 108. The client device 106 may be executing a conventional web client 110, or applications that have been developed for a specific platform or operating system (e.g., iOS, Android, etc.). For example, the client device 106 may be executing a mobile task management application 112 configured to exchange data with the task management platform 102/ The client devices 106 may, for example, be any of a variety of types of devices including a cellular telephone, a smart phone, a personal digital assistant (PDA), a personal navigation device (PND), a handheld computer, a tablet computer, a desktop computer, a notebook computer, a wearable computing device, or other type of movable device.

The client devices 106 may be in communication with the network 104 via a connection 114. Depending on the form of the client device 106, a variety of types of connections and communication networks may be employed. For example, the connection 114 may be a code division multiple access (CDMA) connection, a Global System for Mobile communications (GSM) connection, or other type of cellular connection. In another example, the connection 114 may be a wireless fidelity (Wi-Fi, IEEE 802.11x type) connection, a Worldwide Interoperability for Microwave Access (WiMAX) connection, or another type of wireless data connection. In yet another example, the connection 112 may be a wired connection, such as an Ethernet link, and the network 104 may be a local area network (LAN), a wide area network (WAN), the Internet, or other packet-switched data network.

The client device 106 may be operated by the users of the task management platform 102 to exchange data over the network 104. In various embodiments, the data exchanges within the network system 100 may be facilitated by one or more interface modules 116. The interface modules 116 are coupled to, and provide programmatic and web interfaces respectively to, the application servers 122. The web server 118 may provide task management web interfaces to the client device 106 when using the web client 110. The API server 120 may provide programmatic access to the client device 106 using a programmatic client (e.g., task management application 112), or to a third party server 110 (e.g., one or more servers or client devices) hosting a third party application 124. Further, the data exchange platform 102 may use information retrieved from a third party website hosted by the third party server 110 to support one or more task management features, consistent with some embodiment. For example, the third party website may provide one or more calendaring or communication (e.g., email) services that may be utilized by the task management platform 102 to provide users with a tool to integrate multiple electronic calendars.

The application server 122 may host one or more of the task management applications 124, which provide a variety of task management services discussed herein. The application servers 122 may be coupled via the interface modules 116 to the network 104, for example, via wired or wireless interfaces. The application server 122 is also coupled to one or more database servers 126 that facilitate access to one or more databases 128. In some examples, the application servers 122 can access the databases 128 directly without the need for a database server 126. In some embodiments, the databases 128 may include multiple databases that are both internal and external to the task management platform 102.

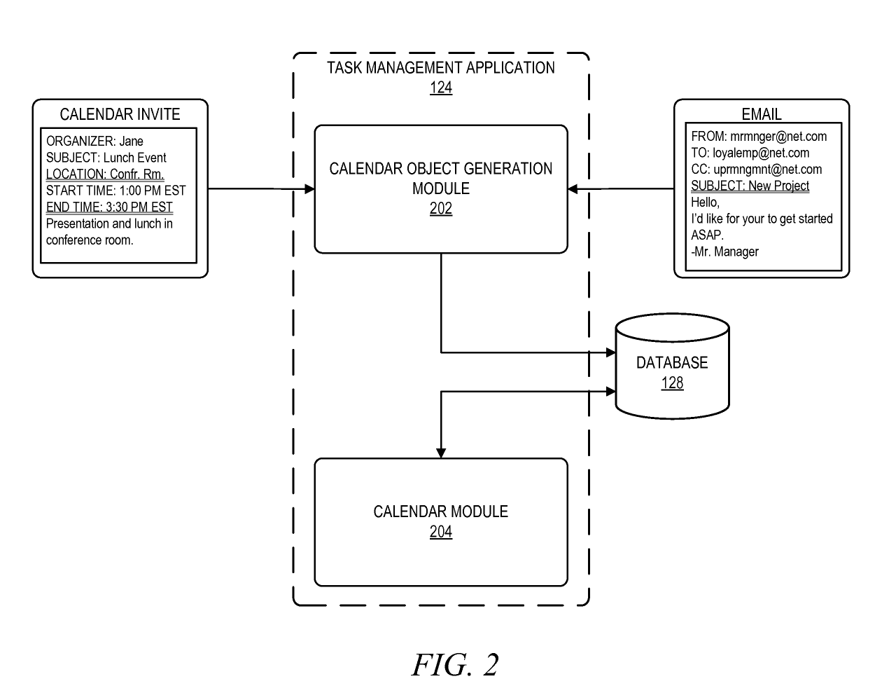

FIG. 2 is a block diagram illustrating an example embodiment of the multiple modules forming the task management application 124, which are provided as part of the task management platform 102. As illustrated in FIG. 2, the task management application 128 may include a calendar object generation module 202 and a calendar module 204. It will be appreciated that in some embodiments the calendar object generation module 202 and the calendar module 204 may be combined into a single module. Further, in some embodiments, one or more modules may be omitted and additional modules may also be included. Additionally, while the modules illustrated in FIG. 2 are discussed below in the singular sense, it should be noted that a multiple versions of the module may be utilized.

The calendar object generation module 202 and the calendar module 204 may be hosted on a dedicated or shared server machine (e.g., application server 122) that is communicatively coupled to enable communication with one or more additional server machines. Further, the calendar object generation module 202 and the calendar module 204 may be communicatively coupled (e.g., via appropriate interfaces) to each other and to various data sources (e.g., third party server 110) so as to allow information to be passed between each of the modules or so as to allow the modules to share and access common data. The calendar object generation module 202 and the calendar module 204 may furthermore access one or more databases 132 via the database servers 128.

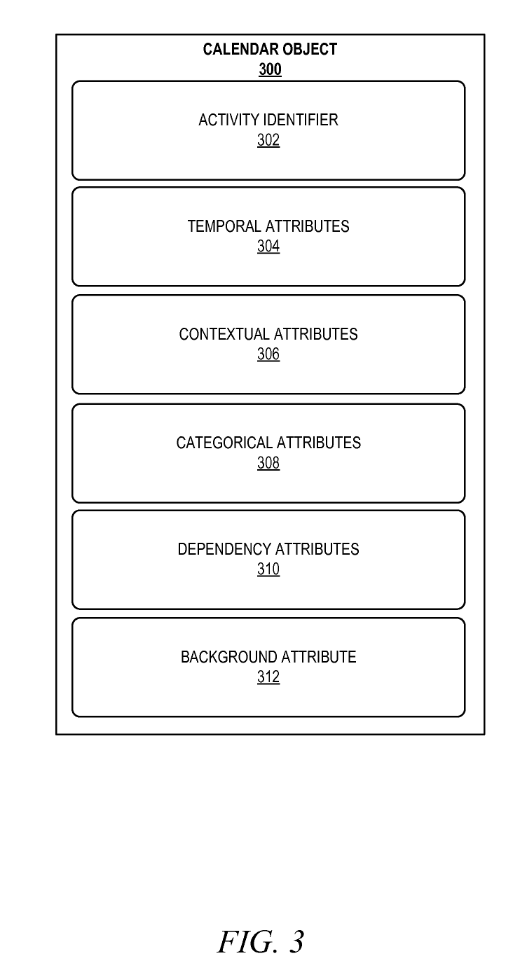

The calendar object generation module 202 may be configured to generate calendar objects corresponding to calendar events. In some embodiments, the creation modules 202 may generate a calendar object in response to and based on user input entered via a calendar object creation interface provided by the interface modules 114. Consistent with this embodiment, a user may specify a plurality of calendar attributes that may collectively define a calendar object. The plurality of calendar attributes may, for example, include a title, an activity or task, temporal attributes, contextual attributes and other content. Further details of the data elements and information forming a calendar object are discussed below in reference to FIG. 3.

In some embodiments, the creation module 202 may generate calendar objects from data defining a calendar event obtained from a third-party application 124 (e.g., Google Calendar®, iCalendar®, Facebook®). In some embodiments, the data may be automatically obtained by the task management application 122 from the third-party application 124 after receiving permission from a user to access an account of the user provided by the third party application 124. The creation module 202 may analyze and parse the data from the third party application 124 to determine the one or more calendar attributes that may define the calendar object from the information contained therein. The creation module 202 may also infer one or more additional attributes based on the determined one or more calendar attributes.

In some embodiments, the generation module 202 may obtain calendar attributes defining a calendar event from an email received by a user of the client device 106. The emails may be automatically obtained by the task management application 124 once the user has permitted the task management application 124 to access an email account of the user. The generation module 202 may analyze and parse the retrieved email to determine the calendar attributes from the information contained therein.

Each calendar object generated by the creation module 202 may be stored as calendar data in the database 128 and in some embodiments, in a machine-readable medium of the client device 106. The task management platform 102 may maintain a user account for each user with corresponding calendar data. Further, each user may access their account and corresponding calendar data using the web client 110 or the task management application 112 executing on the client device 106.

The calendar modules 204 may provide a number of scheduling and calendaring services to users. In particular, the calendar modules 204 may generate a calendar interface that enables users to view, add, and remove calendar events to particular dates and times. Calendar events are visual representations of the calendar objects generated by the calendar object generation module 302. The calendar modules 206 may populate the calendar interface with calendar data stored in the databases 128 or a storage medium contained in the client device 106. The calendar data may alternatively be retrieved, via API, from one or more third party calendar applications or services hosted by the third party server 108.

Consistent with some embodiments, the calendar modules 206 may be configured to access calendar data of a user and analyze the data to determine open time slots in the schedule of the user. The calendar modules 206 may subsequently access a set of calendar objects of the user and select one or more calendar objects from the set to suggest to the user for scheduling in the open time slot. The one or more calendar objects may then be scheduled as calendar events in response to receiving the approval of the user. The scheduled calendar events may include the activity attributes and may maintain a reference to the calendar object.

FIG. 3 is a high-level relationship diagram, in accordance with an example embodiment, illustrating various attributes of a calendar object 300. Consistent with some embodiments, the calendar object 300 may be a species of an intention object. The concept of the intention object is described in U.S. patent application Ser. No. 13/961,516, entitled “METHOD AND SYSTEM FOR INTENTION OBJECT GENERATION,” U.S. patent application Ser. No. 13/961,559, entitled “METHOD AND SYSTEM FOR SELECTIVELY PRESENTING A COLLECTION OF INTENTION OBJECTS,” U.S. patent application Ser. No. 13/961,609, entitled “METHOD AND SYSTEM FOR PROVIDING SCHEDULING SUGGESTIONS,” and in U.S. patent application Ser. No. 14/076,046, entitled “SYSTEM AND METHOD FOR ACTIVITY MANAGEMENT PRESENTATION.”

As illustrated in FIG. 3, the calendar object 300 is a data structure comprising an activity identifier 302, a plurality of activity attributes (e.g., temporal attributes 304, contextual attributes 306, categorical attributes 308, dependency attributes 310) and a background attribute 312. The activity identifier 302 may identify an activity. The activity identifier 302 may be a title, a name, or any other set of words used to refer to the intended event or task. The activity may be any action, movement, event, task or other work to be performed by the user. The activity may be a one-time occurrence or in some embodiments, a recurring activity that is performed at predefined intervals. By way of non-limiting example, the activity may be a work project, a household errand (e.g., house cleaning, grocery shopping, etc.), a phone call to be placed, a meeting or presentation, an email, note or letter to be drafted, or the like.

The plurality of activity attributes may further define the activity identified by the activity identifier 302. The plurality of activity attributes may include temporal attributes 304, contextual attributes 306, and categorical attributes 308. The temporal attributes 304 define time constraints relating to the activity. The temporal attributes 304 may, for example, include a creation date, a completion date, a start time, an end time, a deadline or due date, a frequency (for reoccurring activities), a duration of time necessary for undertaking an activity, a reminder date or time, a travel time, and an amount of time spent performing the activity. The precision and granularity of each of the temporal attributes 304 may be progressively refined based on user input. For example, a user may specify a time constraint as an exact time (e.g., “at 7:26 a.m.”), an approximate time (e.g., “at breakfast”), a time range (e.g., “between 4:00 p.m. and 5:00 p.m.”), an exact date (e.g., “on Aug. 16, 2014”), an approximate date (e.g., “in a couple weeks from today”), a date range (e.g., “between Jul. 9, 2013, and Jul. 11, 2013”), a coarse time frame (e.g. “after my noon meeting but before my 3 P.M. meeting”), or a season (e.g., “summer 2013”). Further, in some embodiments, the temporal attributes 304 may indicate that the calendar object 300 is an all-day calendar event. An all-day calendar event is an event that is associated with an entire day without being committed to a more specific or delineated time period (e.g., 10 P.M.).

The contextual attributes 306 identify at least one context related to the activity. The context may be the circumstances that form a setting relevant to the undertaking or completion for an activity. The contextual attributes 306 may, for example, include a location, a mental state of the user, a proximity to another user, a mode of transportation, or a particular environmental setting.

The categorical attributes 308 include one or more categories or types of activities. In some embodiments, the category is based on one or more of the temporal attributes. For example, a calendar object with an activity that may depend on a relatively long period of time to complete may be classified as a “long term” calendar object. In contrast, a calendar object with an activity that may require only a relatively short period of time may be classified as a “short term” calendar object. In some embodiments, the category may be based on one or more contextual attributes. For example, a calendar object with an activity that must be undertaken at the home of the user may be classified as a “household errand.”

As illustrated in FIG. 3, the calendar object 300 may also include dependency attributes 310. Dependency attributes 310 relate to dependencies of the calendar object 300 on other calendar objects or additional users. The calendar object 300 may be associated with or depend on one or more additional calendar objects. The calendar object 300 may depend on the additional calendar object such that the activity of the calendar object 300 must be undertaken or completed prior to the activity of the additional calendar object. In the case of multiple dependencies, the dependency attributes 310 may also provide an indication of the order in which the activities are to be undertaken. In some embodiments, this order is determined based on the relevancy rank calculated by the relevancy ranking module 216. In some embodiments, the calendar object 300 may depend on an activity, action, or event that does not correspond to a calendar object.

In some embodiments, the dependency attributes 310 of the calendar object 300 may also include information related to an additional user related to or important for undertaking the activity. In some embodiments, the activity or task may be assigned to the additional users. The dependency attributes 310 may include an identifier of the additional user such as a name, a title, an email address, a phone number, an employee identification number, or any other information that may uniquely identify the one or more users.

As illustrated in FIG. 3, the calendar object 300 may also include a background attribute 312 that may indicate whether the calendar object 300 corresponds to a background calendar event. When the calendar object 300 has the background attribute 312, the calendar object 300 corresponds to a background calendar event. In contrast, when the calendar object 300 does not have a background attribute 312, the calendar object 300 corresponds to a foreground calendar event. A background calendar event is an activity that the user has designated as an event for which the user's attendance is optional. Although the user may desire to be aware of a background calendar event, the user may not intend to undertake the activity associated with the background calendar event. For example, a meeting to which a manager was invited out of courtesy may correspond to a background calendar event for the manager because the manager may still desire to be aware of the meeting although he does not plan to attend. In another example, a birthday party attended by children of a parent may be a background calendar event for the parent because the parent may desire to be aware of the birthday party although she does not plan to attend.

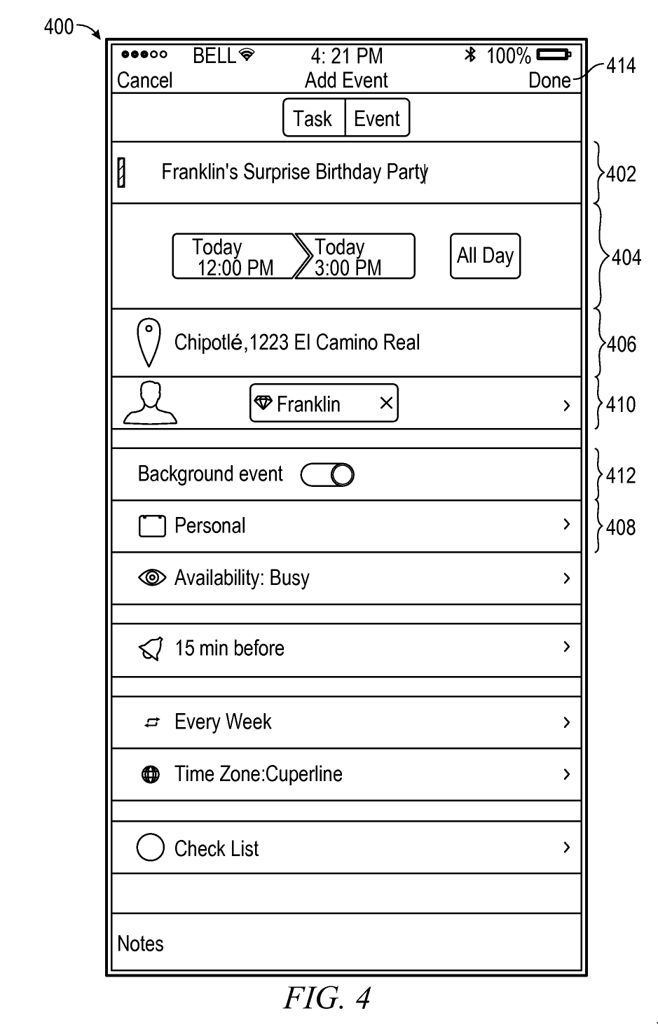

FIG. 4 is an interface diagram illustrating a portion of a calendar object creation interface 400, according to some embodiments. The calendar object creation interface 400 may allow a user to create and commit to create a calendar object (e.g., calendar object 300) that may eventually be displayed as a calendar event. To this end, the calendar object creation interface 400 includes a title field 402, temporal fields 404, contextual fields 406, category field 408, and dependency field 410. The information input into the title field 402, temporal fields 404, contextual fields 406, category field 408, and dependency field 410 may correspond to the activity identifier 302, temporal attributes 304, contextual attributes 306, categorical attributes 308, and dependency attributes 310, respectively. The calendar object creation interface 400 may also include background calendar event field 412, which may be used to designate the calendar event as a background calendar event. A user selection of the background calendar event filed 412 may cause the background attribute 312 to be added to the calendar object. The inclusion of the background attribute 312 in the calendar object may indicate that user attendance is optional. In response to a selection of button 414, a new calendar object may be created in accordance with the entered information. A graphical representation of the newly created calendar object (e.g., a calendar event) may subsequently be added to an appropriate area of a calendar interface.

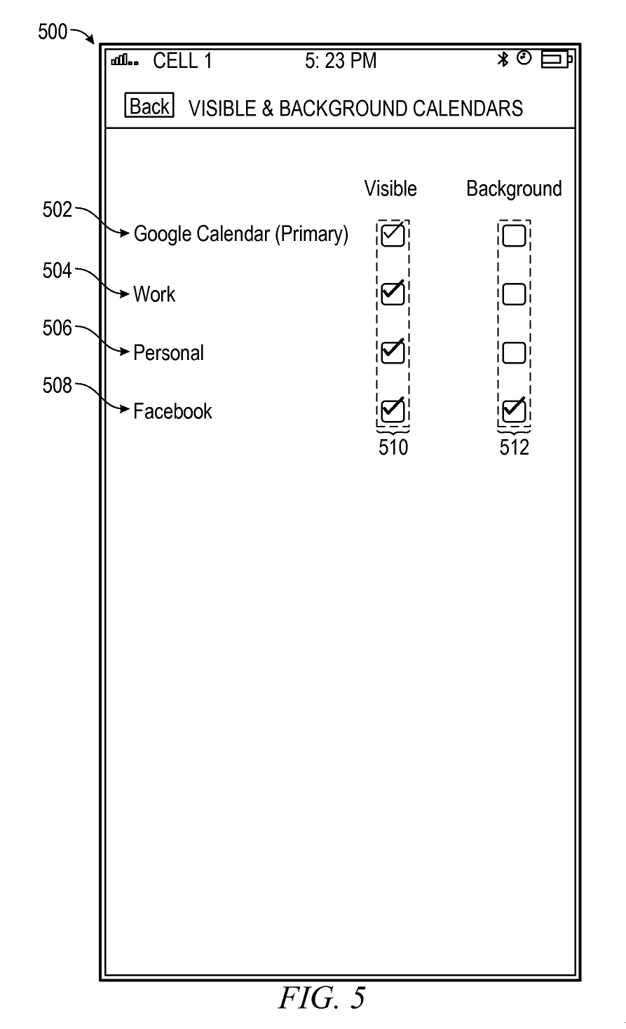

FIG. 5 is an interface diagram illustrating an example calendar source management interface 500, consistent with some embodiments. The calendar source management interface 500 may allow users to specify settings for various calendars included in the task management application 124. The calendar management interface may further allow users to specify sources for calendar data to be used to populate one or more of the user's calendars. As illustrated in FIG. 5, the calendar source management interface 500 includes calendar identifiers 502-508, which identify calendar data sources. For example, calendar identifier 502 corresponds to a calendar provided by third party application 124 (e.g., Google Calendar®). Consistent with some embodiments, a user may be required to provide access credentials (e.g., user name and password) for each calendar source of the calendar identifiers 502-508. The user may be able to specify whether data from a particular calendar data source may be visible on a calendar interface provided by the calendar module 204. To this end, the calendar management interface 700 may include visibility toggles 510, which allow the user to specify the visibility of the corresponding calendar data on the calendar interface. The calendar source management interface 700 may further include background calendar event toggles 512 for each of the calendar identifiers 502-508, which allows the user to configure all calendar objects retrieved from a particular calendar data source as background calendar events.

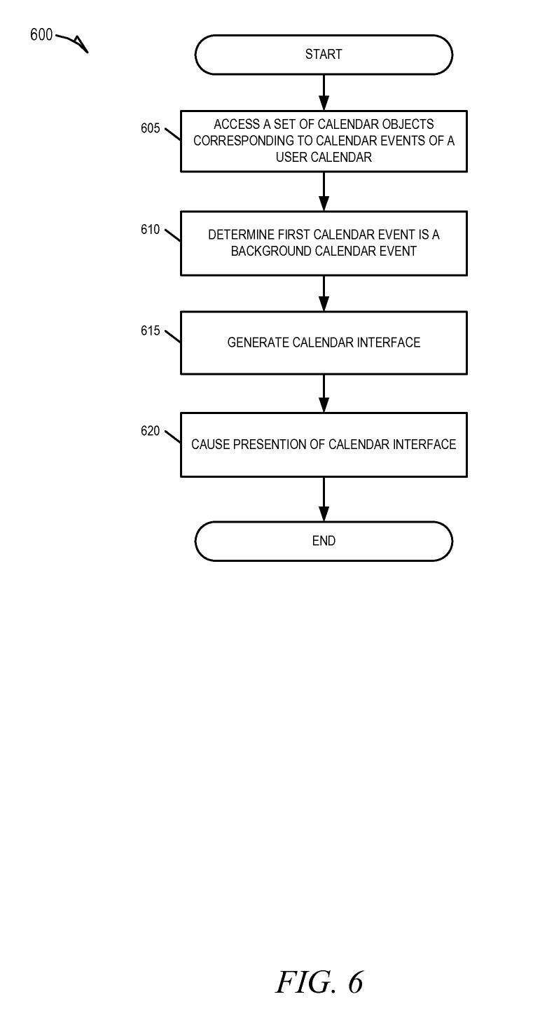

FIG. 6 is a flowchart illustrating an example method 600 for presenting a background calendar event, according to an example embodiment. The method 600 may be embodied in computer readable instructions for execution by one or more processors such that the steps of the method 600 may be performed in part or in whole by the application server 122 or the client device 106 and, in particular, the task management applications 112 and 124.

At operation 605, the calendar module 202 may access a set of calendar objects of a user. Each of the set of calendar object corresponds to calendar events of a user calendar. At least a portion of the calendar objects may correspond to foreground calendar events for which non-optional user attendance is indicated. The accessed calendar objects may be stored in database 128 or in a machine readable medium of the client device 106. In some embodiments, the method 600 may include determining (e.g., by the calendar module 204) that a calendar object (e.g., calendar object 300) from the set of calendar objects corresponds to a background calendar event, at operation 610. The background calendar event being a calendar event for which optional user attendance is indicated. The determination that the calendar object corresponds to a background calendar event may be based on the calendar attributes of the calendar object. For example, the calendar module 204 may determine the calendar object corresponds to a background calendar event by detecting the presence of a background attribute 312 in the calendar object. In another example, the calendar module may determine the calendar object corresponds to a background calendar event by inferring from the attributes 304-310 that the user has not committed to or does not intend to undertake the corresponding activity.

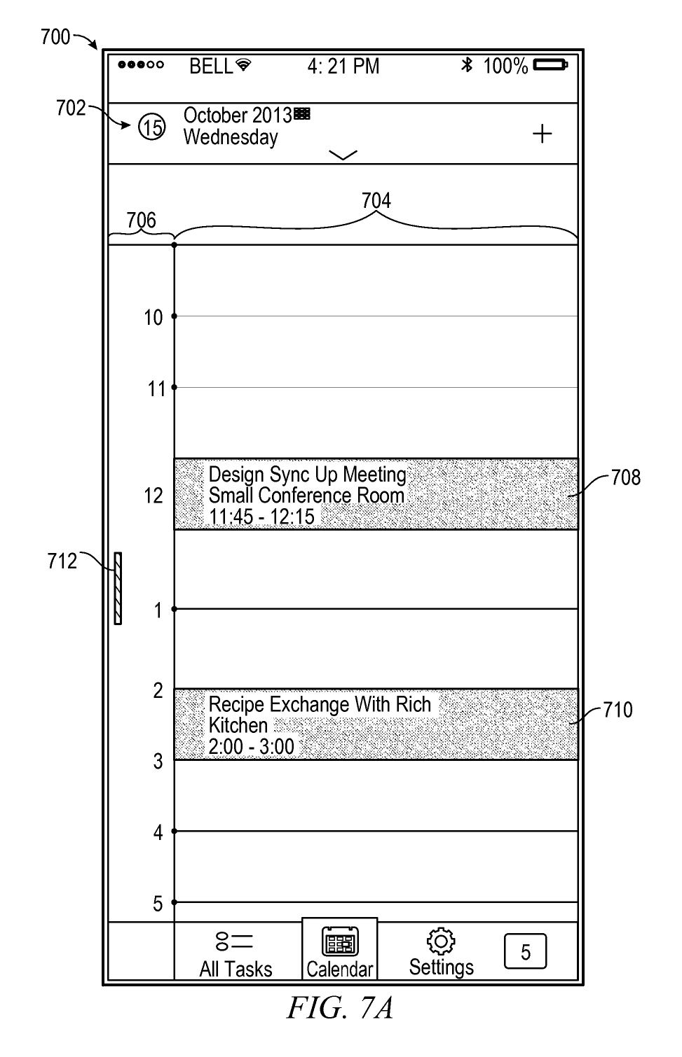

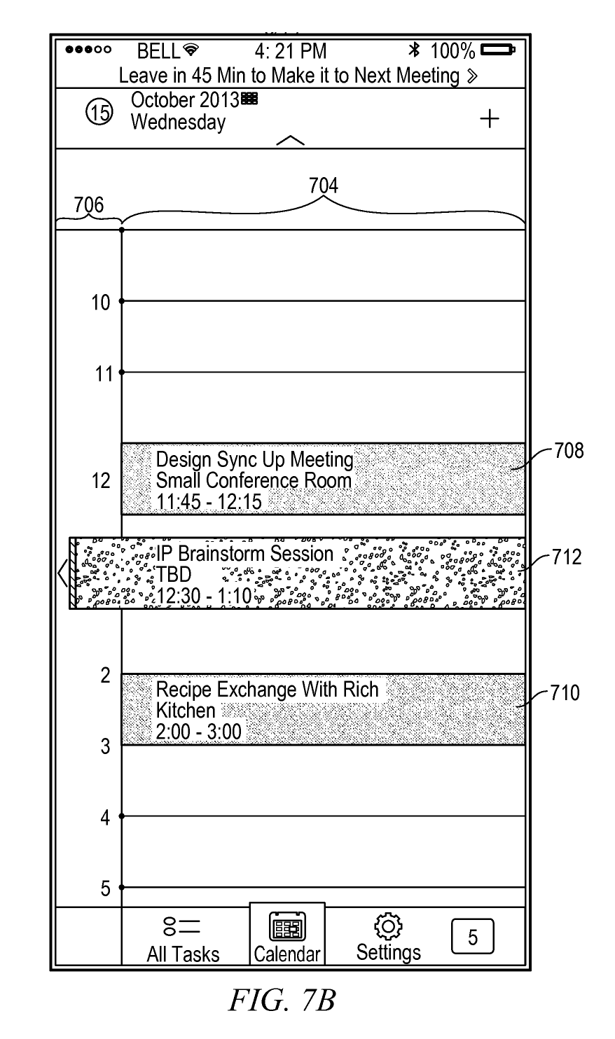

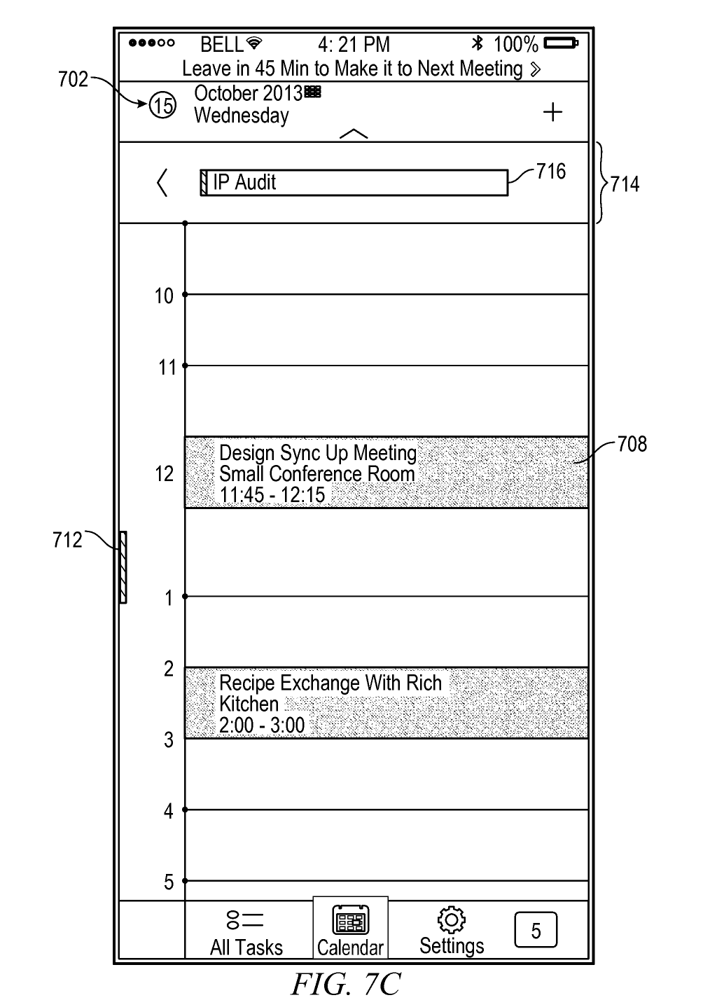

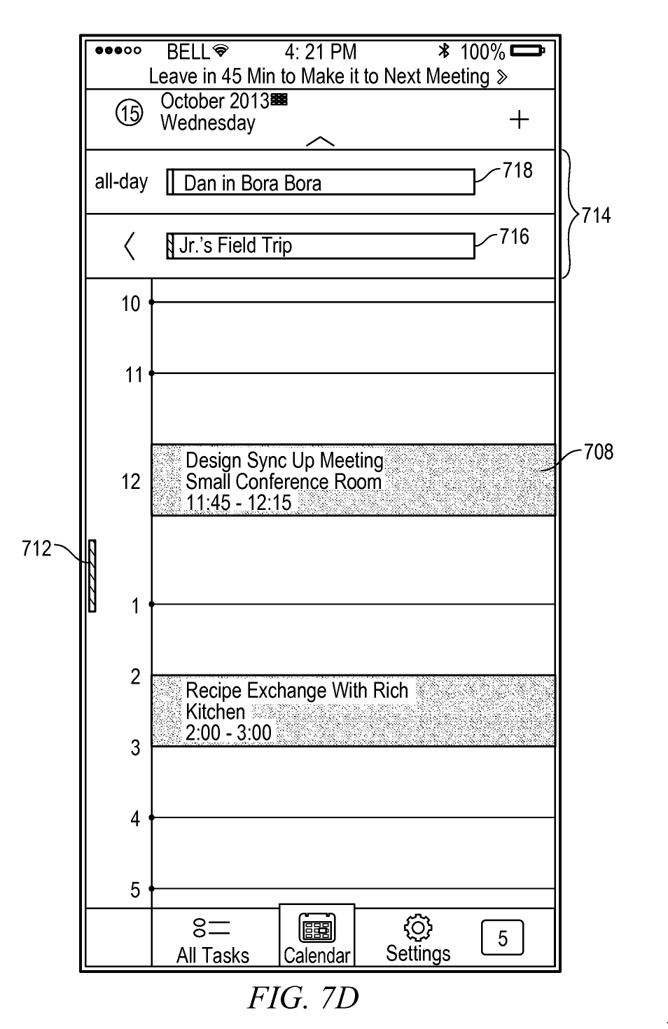

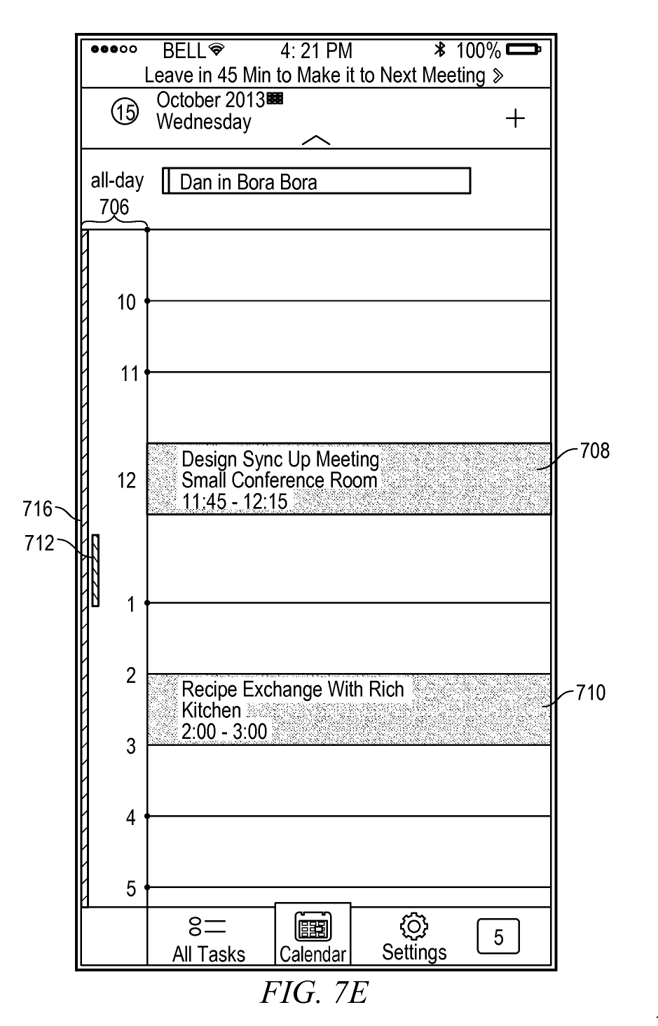

At operation 615, the calendar module 202 may generate a calendar interface. The calendar interface may include a display of each of the set of calendar objects accessed at operation 605. In some embodiments, each of the set of calendar events may, by virtue of their respective calendar attributes, be associated with a specific time period (e.g., day, week, or month). Accordingly, the calendar interface may correspond to the specific time period. The calendar interface may include a primary area and an ancillary area. The primary area may include a display of calendar events for calendar objects that correspond to foreground calendar events. The calendar events displayed in the primary area may be arranged and presented within one or more multiple delineated time periods. The ancillary area may include a display of the background calendar event. The display of the background calendar event may be relegated to the ancillary area so that it may be viewed by a user while not obscuring the view of the foreground calendar events presented in the primary area. Further, the display of the background calendar event may be compressed (e.g., occupying a smaller area of the calendar interface) relative to the display of the foreground calendar events. Further details of the calendar interface are discussed in reference to FIGS. 7A-7E. At operation 620, the calendar module 202 may cause a client device (e.g., client device 106) of the user that cause to present the calendar interface.

FIG. 7A is an interface diagram illustrating an example calendar interface 700, according to some embodiments. Consistent with some embodiments, the calendar interface 700 may be displayed on the client device 106 operated by a user to which the calendar interface 700 pertain. As illustrated in FIG. 7A, the calendar interface 700 may include a date 702, which indicates the date or date range to which the calendar interface 700 pertains. The calendar interface 700 may further include primary area 704 and ancillary area 706. The primary area 704 is illustrated to include calendar events 708 and 710, each of which corresponds to a foreground calendar event. As such, the calendar events 708 and 710 correspond to activities that the corresponding user has committed to undertake. In particular, the calendar event 708 corresponds to a meeting to which the user has committed to attend, and the calendar event 710 corresponds to an exchange with an individual to which the user has committed to engage in. The calendar events 708 and 710 are displayed within the primary area 704 in one of multiple delineated time periods (e.g., 9 AM-10AM). As shown, the primary area 704 may include multiple designators (e.g., lines, hatching, shading, or the like) for signifying the bounds of the multiple delineated time periods. The particular delineated time period in which a calendar event is presented is based on a scheduled start and end time (e.g., specified in the temporal attributes 304 of the corresponding calendar object) of the calendar event.

The ancillary area 706 is illustrated to include a background calendar event 712. The ancillary area 706 may further include designations (e.g., numbers) of the delineated time period in which the foreground calendar events of the primary area 704 are arranged. The background calendar event 712 corresponds to an activity for which the user has designated as optional (e.g., the user has not committed to undertake the activity). In some embodiments, the calendar object (e.g., calendar object 300) corresponding to the background calendar event 712 may include the background attribute 312. The background calendar event 712 is presented in an unobtrusive manner (e.g., relegated to the ancillary area 706) so as not to obscure the presentation of the calendar events 708 and 710 in the primary area 704. Further, the display of the background calendar event 712 is compressed (e.g., flattened from side to side) when compared to the expanded display of the calendar events 708 and 710. As shown, the expanded displays of calendar events 708 and 710 include additional information about the calendar events 708 and 710, whereas the compressed display of the background calendar event 712 is simply an indicator of the background calendar event 712 and does not include additional information. Further, the compressed display of the background calendar event 712 is reduced in sized and flattened laterally when compared to the expanded displays of calendar events 708 and 710. The display of the background calendar event 712 may be expanded in response to user input.

FIG. 7B is an interface diagram illustrating the calendar interface 700 with an expanded display of the background calendar event, consistent with some embodiments. As shown in FIG. 7B, the display of the background calendar event 712 has been expanded. The display of the background calendar event may be expanded in response to user input signifying a selection of the background calendar event 712. For example, the display of the background calendar event 712 may be expanded in response to the user clicking on the compressed display of the background calendar event 712 with a mouse connected to the client device 106. In another example, the display of the background calendar event 712 may be expanded in response to a tap gesture received on a multi-touch surface of the client device 106 on which the calendar interface 700 is displayed. As shown, the expanded display of the background calendar event 712 may span both the ancillary area 704, and the primary area 706. The background calendar event 712 may be returned to the compressed display through further user interaction (e.g., tap gesture on the multi-touch display of the client device 106).

FIG. 7C is an interface diagram illustrating the calendar interface 700 with an all-day calendar event, consistent with some embodiments. As illustrated in FIG. 7C, the calendar interface 700 may be updated to further include a secondary area 714 for displaying calendar events that are associated with the date 702 without having an associated delineated time period (e.g., as specified in the temporal attributes 304). As shown, the secondary area 714 includes an expanded display of an all-day background calendar event 716. The calendar attributes of the all-day background calendar event 718 indicate an association with the date 702, but do not include a further association with one of the delineated time periods displayed in the primary area 704. Further, the all-day background calendar event 716 corresponds to an activity that the user has designated as having optional attendance. As with the background calendar event 712, the display of the all-day background calendar event 716 may be compressed in response to user input.

FIG. 7D is an interface diagram illustrating the calendar interface 700 with multiple all-day calendar events, consistent with some embodiments. As illustrated in FIG. 7D, the secondary area 714 of the calendar interface 700 has been updated to include an all-day calendar event 718, which corresponds to an activity that the user has committed to undertake (e.g., a foreground calendar event). As shown, both the all-day background calendar event 716 and the all-day calendar event 718 may be presented together in the secondary area 714.

FIG. 7E is an interface diagram illustrating the calendar interface 700 with a compressed display of an all-day background calendar event, consistent with some embodiments. As illustrated in FIG. 7E, the display of the all-day background calendar event 716 has been compressed in response to user input. As with the background calendar event 706, the compressed display of the all-day background calendar event 716 is relegated to the ancillary area 704. As shown, the compressed display of the all-day background calendar event 716 spans the entire vertical length of the ancillary area 706. Further, as shown, the background calendar event 706 and the all-day background calendar event 716 are temporally overlapped. As a result, the compressed displays of the background calendar event 706 and the all-day background calendar event 716 are staggered.

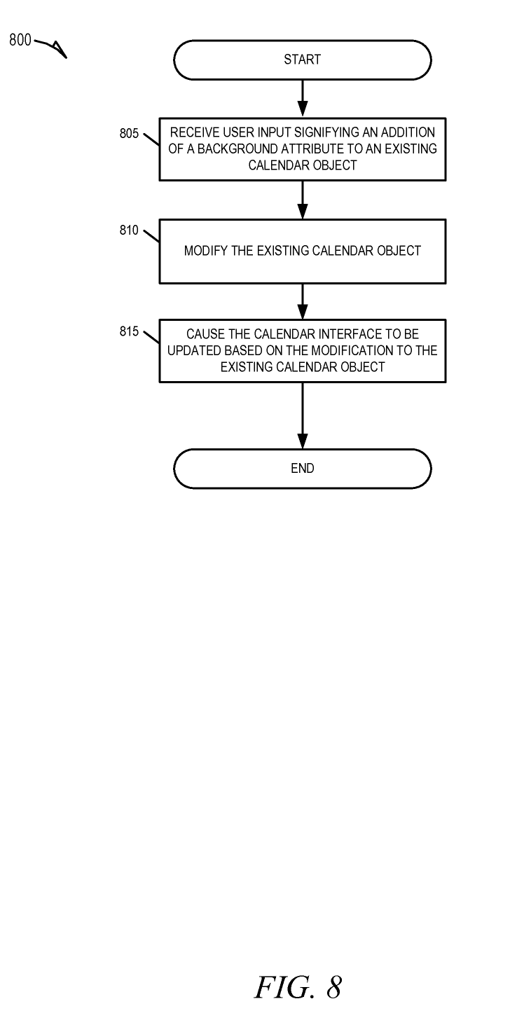

FIG. 8 is a block diagram illustrating an example method 800 for updating the calendar interface 700, consistent with some embodiments. In some embodiments, the method 800 may commence at the termination of method 600. The method 800 may be embodied in computer readable instructions for execution by one or more processors such that the steps of the method 800 may be performed in part or in whole by the application server 122 or the client device 106 and, in particular, the task management applications 112 and 124.

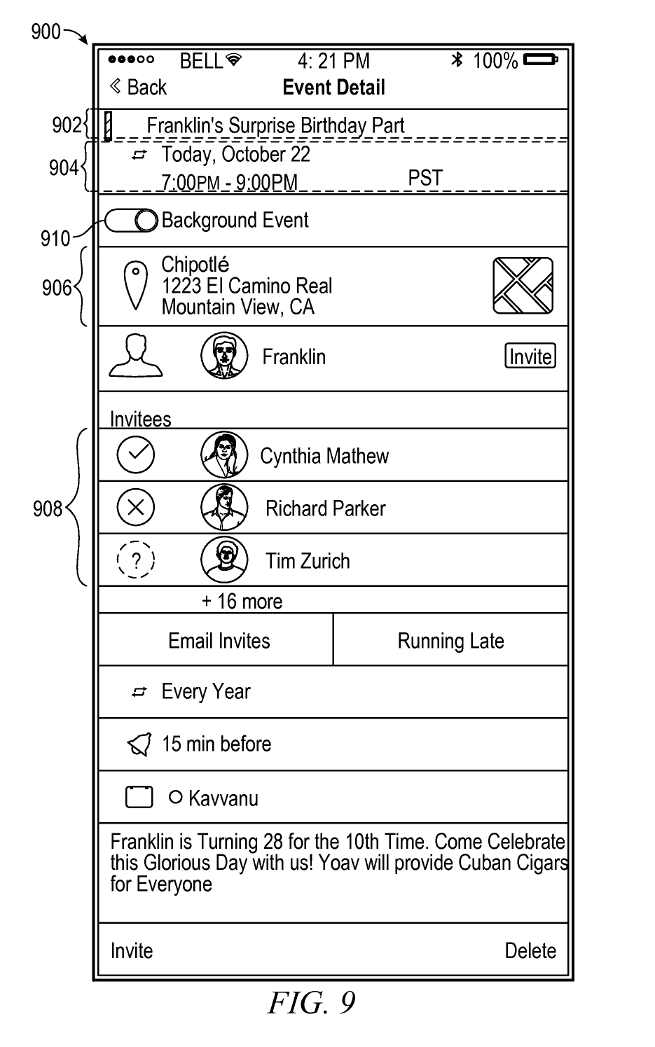

At operation 805, user input signifying an addition of a background attribute to an existing calendar object is received (e.g., by the task management applications 112 or 124). The user input may be received from a detailed display of the existing calendar object. Further details of the detailed display of an existing calendar object are discussed below in referenced to FIG. 9.

FIG. 9 is an interface diagram illustrating a detailed view 900 of an example calendar object, according to some embodiments. In particular, FIG. 9 illustrates the detailed view 900 of the calendar object created via the creation interface 600. The detailed view 900 may include title 902, temporal information 904, contextual information 906, and dependency information 908. A user may edit the title 902, temporal information 904, contextual information 906, and dependency information 908 within the detailed view interface 900. The detailed view interface 900 may further include background toggle 910, which may be used to by a user to designate the existing calendar event as a background calendar event. Such a designation may convey the user's designation of the existing calendar event as an event for which the user's attendance is optional.

Returning back to FIG. 8, at operation 810 the calendar module 202 may modify the existing calendar object corresponding to the calendar event in accordance with the user input (e.g., toggling of the background toggle 910) received at operation 805. At operation 815, the calendar module 202 may cause the calendar interface to be updated based on the modification to the existing calendar object. The updating of the calendar interface may include shifting the display of the calendar event corresponding to the calendar object from the primary area to the secondary area. The updating of the calendar interface may further include a compressed display of the calendar event corresponding to the calendar object.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

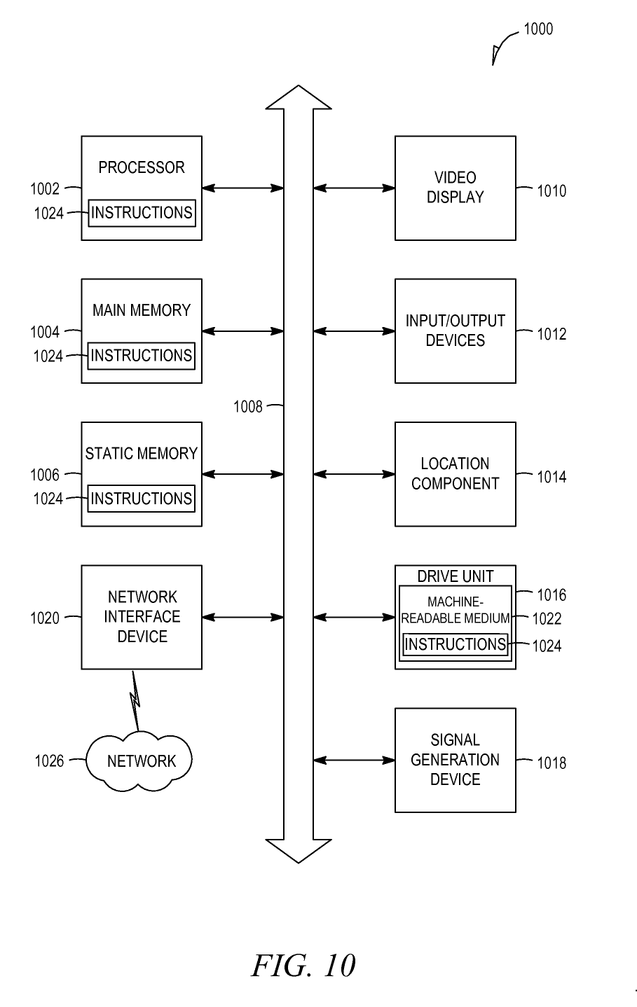

FIG. 10 is a block diagram of a machine in the example form of a computer system 1000 within which instructions for causing the machine to perform any one or more of the methodologies discussed herein may be executed. In alternative embodiments, the machine operates as a standalone device or may be connected (e.g., networked) to other machines. The computer system 1000 may correspond to client device 106, third party server 108, or server 122, consistent with some embodiments. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a smart phone (e.g., iPhone®), a tablet computer, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes one or more input/output (I/O) devices 1012, a location component 1014, a disk drive unit 1016, a signal generation device 1018 (e.g., a speaker), and a network interface device 1020. The I/O devices 1012 may, for example, include a keyboard, a mouse, a keypad, a multi-touch surface (e.g., a touchscreen or track pad), a microphone, a camera, and the like.

The location component 1014 may be used for determining a location of the computer system 1000. In some embodiments, the location component 1014 may correspond to a GPS transceiver that may make use of the network interface device 1020 to communicate GPS signals with a GPS satellite. The location component 1014 may also be configured to determine a location of the computer system 1000 by using an internet protocol (IP) address lookup or by triangulating a position based on nearby mobile communications towers. The location component 1014 may be further configured to store a user-defined location in main memory 1004 or static memory 1006.

In some embodiments, the network interface device 1020 may correspond to a transceiver and antenna. The transceiver may be configured to both transmit and receive cellular network signals, wireless data signals, or other types of signals via the antenna, depending on the nature of the computer system 1000.

### Machine-Readable Medium

The disk drive unit 1016 includes a machine-readable medium 1022 on which is stored one or more sets of data structures and instructions 1024 (e.g., software) embodying or used by any one or more of the methodologies or functions described herein. The instructions 1024 may also reside, completely or at least partially, within the main memory 1004, static memory 1006, and/or within the processor 1002 during execution thereof by the computer system 1000, with the main memory 1004 and the processor 1002 also constituting machine-readable media 1022.

Consistent with some embodiments, the instructions 1024 may relate to the operations of an operating system (OS). Further, the instructions 1024 may relate to operations performed by applications (commonly known as “apps”), consistent with some embodiments. One example of such an application is a mobile browser application that displays content, such as a web page or a user interface using a browser.

While the machine-readable medium 1022 is shown in an example embodiment to be a single medium, the term “machine-readable medium” may include a single medium or multiple media (e.g., a centralized or distributed database, and/or associated caches and servers) that store the one or more data structures or instructions 1024. The term “machine-readable medium” shall also be taken to include any tangible medium or tangible device that is capable of storing, encoding, or carrying instructions 1024 for execution by the machine and that cause the machine to perform any one or more of the methodologies of the present disclosure, or that is capable of storing, encoding or carrying data structures used by or associated with such instructions 1024. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The communications network 1026 may correspond to the network 104, consistent with some embodiments. The instructions 1024 may be transmitted using the network interface device 1020 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although the embodiments of the present inventive subject matter have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

What is claimed is:

1. A method comprising:
accessing a set of calendar objects corresponding to calendar events of a user calendar, the calendar events comprising at least one foreground calendar event for which non-optional user attendance is indicated, and a background calendar event for which optional user attendance is indicated;
generating, using a processor of a machine, a calendar interface comprising a primary area and an ancillary area, the primary area including a display of the at least one foreground calendar event, the at least one foreground calendar event being presented within a delineated time period, the ancillary area including a display of the background calendar event, the display of the background calendar event being laterally compressed relative to the display of the at least one foreground calendar event;
causing presentation of the calendar interface on a client device.

2. The method of claim 1, further comprising
receiving user input signifying a selection of the display of the background calendar event; and
expanding the display of the background calendar event such that the display of the background calendar event spans the primary area and ancillary area.

3. The method of claim 1, further comprising
receiving user input signifying an addition of a background attribute to a particular calendar object of the set of calendar objects, the background attribute indicating that the other calendar object is a background calendar event;
in response to receiving the user input, modifying the particular calendar object to include the background attribute; and
in response to the particular calendar object including the background attribute, updating the calendar interface such the ancillary area includes a display of the calendar event corresponding to the particular calendar object and the primary area excludes a display the calendar event corresponding to the particular calendar object.

4. The method of claim 3, wherein the particular calendar object and the background the background calendar event correspond to an identical time, and wherein the displays of the background calendar event and the calendar event corresponding to the particular calendar object are staggered within the ancillary area.

5. The method of claim 1, further comprising determining a scheduled time for the set of calendar objects, wherein the corresponding calendar events are presented in the delineated time periods of the calendar interface according to the scheduled time.

6. The method of claim 5, wherein the background calendar event is an all-day calendar event, and wherein the display of the background calendar event spans a vertical length of the ancillary area.

7. The method of claim 1, further comprising determining a particular calendar object from the set of calendar objects corresponds to the background calendar event based on one or more attributes of the particular calendar object.

8. The method of claim 1, wherein the calendar interface further includes a secondary area for presenting all-day events.

9. The method of claim 1, wherein the ancillary area further includes designations of the delineated time periods.

10. The method of claim 1, wherein the set of calendar objects pertains to a particular day.

11. A tangible machine-readable storage medium embodying instructions that, when executed by a machine, cause the machine to perform operations comprising:
accessing a set of calendar objects corresponding to calendar events of a user calendar, the calendar events comprising at least one foreground calendar event for which non-optional user attendance is indicated, and a background calendar event for which optional user attendance is indicated;
generating, using a processor of a machine, a calendar interface comprising a primary area and an ancillary area, the primary area including a display of the at least one foreground calendar event, the at least one foreground calendar event being presented within a delineated time period, the ancillary area including a display of the background calendar event, the display of the background calendar event being compressed relative to the display of the at least one foreground calendar event;
causing presentation of the calendar interface on a client device.

12. The tangible machine-readable storage medium of claim 11, wherein the operations further comprise:
receiving user input signifying a selection of the display of the background calendar event; and
expanding the display of the background calendar event such that the display of the background calendar event spans the primary area and ancillary area.

13. The tangible machine-readable storage medium of claim 11, wherein the operations further comprise:
receiving user input signifying an addition of a background attribute to a particular calendar object of the set of calendar objects, the background attribute designating the particular calendar object as a background calendar event;
in response to receiving the user input, modifying the particular calendar object to include the background attribute; and
in response to the particular calendar object including the background attribute, updating the calendar interface such the ancillary area includes a display of the calendar event corresponding to the particular calendar object and the primary area excludes a display the calendar event corresponding to the particular calendar object.

14. The tangible machine-readable storage medium of claim 13, wherein the particular calendar object and the background the background calendar event correspond to an identical time, and wherein the displays of the background calendar event and the calendar event corresponding to the particular calendar object are staggered within the ancillary area.

15. The tangible machine-readable storage medium of claim 11, wherein the operations further comprise determining a scheduled time for each of the set of calendar objects, wherein the corresponding calendar events are presented in the calendar interface according to the scheduled time.

16. The tangible machine-readable storage medium of claim 11, wherein the background calendar event is an all-day calendar event, and wherein the display of the background calendar event spans a vertical length of the ancillary area.

17. The tangible machine-readable storage medium of claim 11, detecting a presence of a background attribute in the calendar object corresponds to the background calendar event.

18. The tangible machine-readable storage medium of claim 11, wherein the ancillary area further includes designations of delineated time periods.

19. The tangible machine-readable storage medium of claim 11, wherein the set of calendar objects pertains to a particular week.

20. A system comprising:
a processor of a machine;
a tangible machine-readable storage medium storing a set of calendar objects corresponding to calendar events of a user calendar, the calendar events comprising at least one foreground calendar event for which non-optional user attendance is indicated, and a background calendar event for which optional user attendance is indicated; and
an calendar module to generate, using the processor of the machine, a calendar interface comprising a primary area and an ancillary area, the primary area including a display of the at least one foreground calendar event, the at least one foreground calendar event being presented within a delineated time period, the ancillary area including a display of the background calendar event, the display of the background calendar event being laterally compressed relative to the display of the at least one foreground calendar event, the calendar module further to cause presentation of the calendar interface on a client device.
